(19) United States
(12) Patent Application Publication
(10) Pub. No.: US 2008/0083893 A1
(43) Pub. Date: Apr. 10, 2008

(54) Voice-controlled faucet for water conservation

(76) Inventor: Steven Rubenstein, Bothell, WA (US)

Correspondence Address: Steven Rubenstein, 504 224th Place SE, Bothell, WA, 98021, US

(21) Appl. No.: 11/542,840

(22) Filed: Oct. 4, 2006

(51) Int. Cl. F16K 31/02

(52) U.S. Cl. 251/129.04

(57) ABSTRACT

The invention provides simplified methods and devices for conserving water by controlling water flow from plumbing fixtures using voice or sound commands. One aspect of the invention provides a method for conserving water that includes the step of: providing a faucet or showerhead or the like with voice or sound control of the amount of water flow, which control does not include control of temperature of water exiting the fixture. Another aspect of the invention provides a device for conserving water that includes a voice or sound command-responsive control unit that controls the amount of flow of water from a plumbing fixture such as a faucet or showerhead by actuating a valve that is disposed downstream of the mixing of hot and cold water. Valve states may include only open and closed, i.e., on and off, or may optionally include one or more intermediate flow positions.

### FIELD OF THE INVENTION

The invention relates generally to the field of voice-controlled and voice-activated plumbing fixtures such as faucets, spigots and showerheads.

### BACKGROUND OF INVENTION

Fresh water is a precious resource that is obtained from natural sources or is purified from non-fresh water sources such as sea water or waste water by any of a number of methods. The total fresh water resources of many areas are being stressed by growing demands due to increasing population. Water conservation refers to reducing the use of fresh or potable water, through technological or social methods. The goals of water conservation efforts include:

Sustainability—To ensure availability for future generations, the withdrawal of fresh water from an ecosystem should not exceed its natural replacement rate.

Energy conservation—Water pumping, delivery and waste water treatment facilities consume a significant amount of energy. In some regions of the world (for example, California) over 10% of total electricity consumption is devoted to water management.

Habitat conservation—Minimizing human water use helps to preserve fresh water habitats for local wildlife and migrating waterfowl, as well as reducing the need to build new dams and other water diversion infrastructure.

A number of technological measures have been shown to be effective in conserving fresh water.

Low-Flow Showerheads—Showers account for about 20 percent of total indoor water use. By replacing standard 4.5-gallon-per-minute showerheads with 2.5-gallon-per-minute heads, which cost less than $5 each, a family of four can save approximately 20,000 gallons of water per year. Although individual preferences determine optimal shower flow rates, properly designed low-flow showerheads are available to provide the quality of service found in higher-volume models.

Faucet Aerators. Faucet aerators, which break the flowing water into fine droplets and entrain air while maintaining wetting effectiveness, are inexpensive devices that can be installed in sinks to reduce water use. Aerators can be easily installed and can reduce the water use at a faucet by as much as 60 percent while still maintaining a strong flow. More efficient kitchen and bathroom faucets that use only 2 gallons of water per minute--unlike standard faucets, which use 3 to 5 gallons per minute—are also available.

Pressure Reduction. Because flow rate is related to pressure, the maximum water flow from a fixture operating on a fixed setting can be reduced if the water pressure is reduced. For example, a reduction in pressure from 100 pounds per square inch to 50 psi at an outlet can result in a water flow reduction of about one-third.

Water flow from faucets, spigots, showerheads and the like is typically manually controlled, by an individual, and sometimes controlled using foot pedals. Voice-activated systems for controlling the flow and properties, such as temperature, of water from plumbing fixtures have been described. The following patents and publications are background to the present invention.

U.S. Pat. No. 5,184,642, which is incorporated by reference herein in its entirety, discloses a retrofit system for converting a conventional hot and cold water faucet arrangement to automatic electric control. A solenoid valve and U-shaped tubes at either end are inserted into each riser (hot and cold risers). The valves are responsive to a control panel for setting flow rate and/or temperature.

U.S. Pat. No. 5,868,311, which is incorporated by reference herein in its entirety, discloses a water faucet assembly providing touchless water temperature and water flow adjustment. The assembly comprises a spout, a water mixing valve, at least one proximity sensor, and a microcomputer. The water mixing valve provides a mix and controls the flow of hot water from a hot water supply and cold water from a cold water supply to the spout.

U.S. Pat. No. 6,317,717, which is incorporated by reference herein in its entirety, discloses a voice-activated faucet is provided with a valve coupled between the faucet and a water line for allowing water to flow to the faucet upon the actuation thereof.

U.S. Pat. Nos. 5,345,538, 5,335,313 and 5,430,826 each disclose voice activated control systems and each is incorporated by reference herein in its entirety.

U.S. Pat. No. 5,441,075, which is incorporated by reference herein in its entirety, discloses a shower control valve assembly.

However, while there is a continuing need to conserve fresh water, none of the voice-activated control systems of the referenced patents are designed with the primary goal of facilitating water conservation.

In view of the above, what is needed and desirable are simplified voice controlled faucet, spigot and showerhead systems that readily adapt to preexisting faucet, spigot and showerhead installations and provide the essential functionalities for reducing water use therefrom.

### SUMMARY OF INVENTION

One embodiment of the invention provides a method for conserving water that includes the step of: providing a faucet or showerhead or the like with voice or sound control of the amount of water flow, said control not including control of temperature. In one variation, the control provided consists of turning on and turning off the flow of water.

One embodiment provides a water flow control device for conserving water that includes: a control unit responsive to voice or sound commands; and a water flow control valve under control of the control unit; the device comprising one or more connecting elements sized and configured to connect the device to a plumbing fixture selected from the group consisting of a faucet and a shower fixture. In one variation, the device provides voice or sound actuated control consisting essentially of toggling the valve between an open state and a closed state to turn water flow on and off.

A related embodiment provides a method for conserving water that includes the steps of: installing a device as described to a plumbing fixture; and controlling the amount of flow of water flow by voice or sound actuation of the device, whereby water is conserved in comparison to operation of the fixture without the device. In one variation, the fixture is a faucet and the device is attached to the water-exiting end of the faucet. In another variation, the fixture is a shower fixture and the device is attached between a shower head and a water pipe that supplies water to the shower head.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

FIG. 1 shows a faucet embodiment of the invention.

FIG. 2 shows another faucet embodiment of the invention,

FIG. 3 shows a shower embodiment of the invention.

FIG. 4 shows another shower embodiment of the invention.

### DETAILED DESCRIPTION

The present invention provides methods and devices for conserving water by providing voice and/or sound control of water flow from faucets, showerheads and the like.

The water flow control devices of the invention may advantageously be retrofitted to preexisting, already installed faucets, shower fixtures and the like or be installed originally with such fixtures.

One embodiment of the invention provides a device for conserving water that includes a sound command-responsive control unit that controls the amount of flow of water from a plumbing fixture such as a faucet or showerhead. The amount of flow may be controlled by actuation of a valve by the control unit.

In one variation, the device is adapted for attachment to the water-exiting end of a faucet. For example, the device may screw into screw threads present at the water exiting end of the faucet. Thus, at least the valve part of the device may be attached to the water exiting end of a faucet. In another variation, the device is adapted for simultaneous attachment to a showerhead and a water conduit, such as a water pipe, supplying water to the showerhead. Thus, at least the valve part of the device may be operably disposed between a showerhead and a water conduit supplying the showerhead.

If any mixing of hot water and cold water occurs prior to the water-exiting end of a plumbing fixture, as is common for a residential faucet or showerhead, the device of the invention is preferably disposed downstream of the hot and cold water mixing junction or valve (i.e., “post-mixing”) so that the device of the invention does not control the temperature of the water exiting the fixture. Instead, for fixtures fed by both a hot and cold water source, such as hot and cold water risers of a sink faucet, temperature is controlled by the preexisting mixing valve(s). Thus, control of water flow by the device of the invention and by the control unit thereof consists essentially of controlling the amount of water exiting a fixture to which the device is attached. For example, control of water flow by the device of the invention may consists essentially of toggling between two states, such as between an on state and off state. This design maximizes water conservation while minimizing complexity of the control system.

For example, hand dishwashing using a continuous flow of water from a sink faucet is generally highly wasteful of water because the stream of water is not efficiently utilized due to its continuous nature and because it is time-consuming and impractical for the human washer to repeatedly turn the flow of water off, when the water is not needed, and back on throughout the process of washing several items, especially using standard hand-controlled faucets. The present invention permits a verbal or other sound command from the human washer to quickly turn the flow of water on and off or otherwise adjust the amount of flow of water without removing their hands from the items being washed and more quickly than is possible by manual manipulation of the standard faucet controls. It should also generally be seen as an advantage of the present invention that a human user can turn off or turn down the amount of water flow from any sort of fixture, such as a faucet or showerhead, more quickly using a vocal command than is possible by manipulation of a standard manual control, thereby reducing the amount of water used for any session of water consumption.

The control unit of the device generally includes a microphone of any suitable kind that generates a signal in response to sound or otherwise responds to sound and at least one microprocessor that processes voice commands or sound commands generally (received from the microphone or other sound receiving device) and controls the state of the valve that controls the amount of flow of water. Control units of devices according to the invention may process any type of vocal or other sound commands in any way. For example, the control unit may recognize vocalization of specific words for “on” and “off,” in one or more desired languages that correspond to the desired action. Alternatively, the control unit may toggle between one or more valve states, such as fully open (water flow fully on) and fully closed (water flow off) and optionally intermediary valve states in response to the same vocalization, for example, “go!” to advance to the next state, “go!” again to advance to the next state and so on. The vocalization is not required to be a word of a language that is associated by its meaning with the desired command; it may be any vocal sound or other human-generated sound of any sort, such as a whistle (with or without use of a whistle device), click, yodel, grunt, finger-snap or foot-tap.

In one embodiment of the invention, the device toggles between a full-on and full-off valve state. Here, the amount of maximum water flow in the full-on state is determined by the amount of water supplied to the valve part of the device, which may or may not be controlled by standard fixture valve controls upstream of the valve.

In another embedment of the invention, the device is capable of a full-on state a full-off state and at least one intermediary state, such as a half on state and/or a quarter-on state. Thus, here, a lesser flow than the maximal flow achievable may be effectuated by the device as desired. In one variation, the device responds to a command, such as “half” that linguistically corresponds to the desired intermediary amount of water flow or is otherwise assigned or selected to represent the desired state of water flow.

Devices of the invention may be electrically powered by a battery or directly from an electrical outlet or directly wired into home or building electrical wiring generally. Combinations are also within the scope of the invention.

Devices according to the invention may be configured in various ways. For example, at least the primary components of the device can be integrated together into a unitary “box” or form that attaches to a faucet, showerhead or the like as described herein. If the device is battery powered, the battery can be part of the singular box or form. If the device is powered via an electrical cord, the cord will connect the device to the electrical source. In a different example, primary components of the device may be remote from one another. In one such embodiment, there is: a valve portion of the device that connects to the faucet, shower fixture or the like as described herein; a control unit that includes the voice/sound control circuitry/logic (which may include a microprocessor), any battery if battery operated, any required power supplies, an electrical cord for plugging into an electrical outlet if so configured; and a cord or other connecting element that operably connects the control unit to the valve portion. In the case of electrically driven valves, the connecting cord can include one or more electrical wires for actuating the valve under control of the control unit. For a pneumatic or hydraulically actuatable valve, the connecting element may include a pneumatic or hydraulic line (conduit) and the control unit may include a suitable pneumatic pressure source or hydraulic pressure source.

The devices and methods of the invention may employ any suitable sort of water flow controlling valve. For example, power-operated control valves including, but not limited to, globe, diaphragm, pinch, knife or gate, needle, butterfly, ball, and plug type control valves may be employed. The valve may be actuated (opened and closed, toggled between on/off or variably adjusted) under control of the microprocessor in response to voice or sound by electric (for example using a motor or solenoid), pneumatic, electro-hydraulic, and/or electro-hydraulic means.

In one embodiment, the device of the invention employs a normally open valve so that water flows normally through the valve when the valve is not actuated, for example, when it is not desired to control the amount of water flow using the device. Thus, by using a normally open valve the device does not need to be turned on, i.e., use any power, to obtain water flow through the valve. In this case, water flow can be obtained by using the regular manual controls of the faucet, shower fixture, or the like. Various commercially available valves may be readily adapted for use in the devices of the present invention. For example, ASCO Red Hat general purpose 2-way normally open solenoid valves, 1.0 inch or 0.5 inch size, may be used (ASCO, Florham Park, N.J. USA). Suitable solenoid type valves are also available from Peter Paul Electronics Co., Inc. (New Britain, Conn. USA).

Use of a normally closed valve is also within the scope of the invention, but is less preferred than use of a normally open valve. Normally closed valves are also commercially available from the above-named valve manufacturers.

Devices of the invention may also be provided with a manual override switch or lever that physically opens and closes the voice/sound-controlled flow valve or another flow valve that is provided in line with the voice/sound controlled flow valve. Inclusion of this feature is desirable in the case that users may want to use the device as the primary flow control over the faucet or shower, rather than the preexisting flow controls of the faucet or shower.

The invention is further described below with reference to the appended figures.

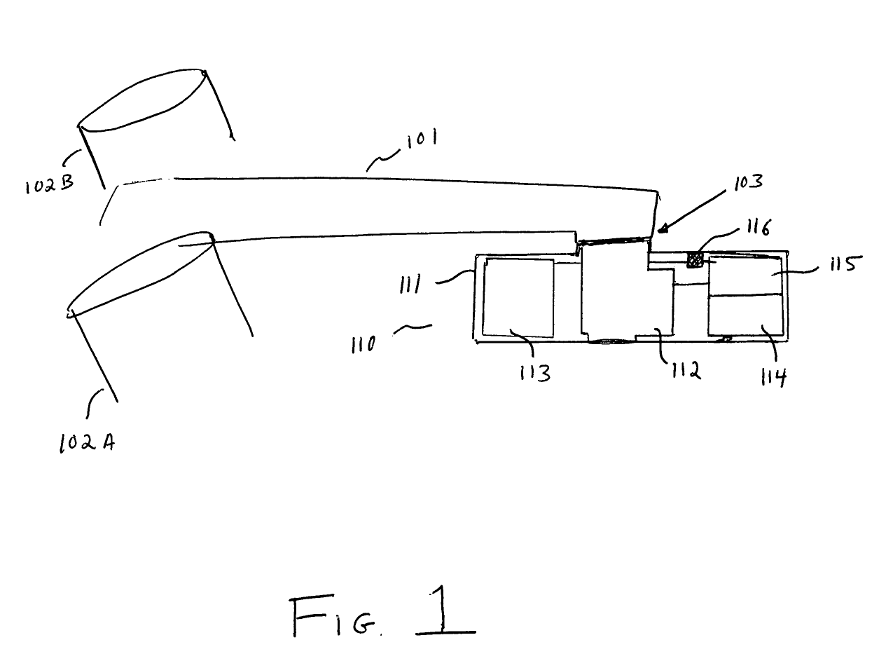

FIG. 1 illustrates a battery-powered faucet embodiment of the invention. Device 110 is connected to a standard faucet 101. Faucet 101 is connected to hot and cold water controls 102A and 102B and has a water-exiting end 103. Water-exiting end 103 of the faucet 101 has screw threads (not shown) as many standard faucets into which an aerator may be attached. Typically, if an aerator is already installed on the faucet, it will be unscrewed before installing a water flow control device according to the invention. Here, device 110 is attached to faucet 101 by screwing the device into the screw threads at the water-exiting end 103. Device 110 includes an outer casing 111 that contains a two-way, normally open solenoid valve 112, a battery 113, a processor control 114, control circuitry 115 under control of processor 114 and a microphone 116. Powered by the battery, the processor controls the state of the valve as described herein in response to voice commands, or sounds commands generally. Device 110 may also be provided with a general power switch (not shown) for turning the device on and off. The on/off switch may, for example, be a water-tight sealed push-button toggle switch. The water-exiting end of device 110 may also include and/or be adapted to connect to an aerator, such as a standard faucet aerator, for example by having screw threads adapted to connect to an aerator.

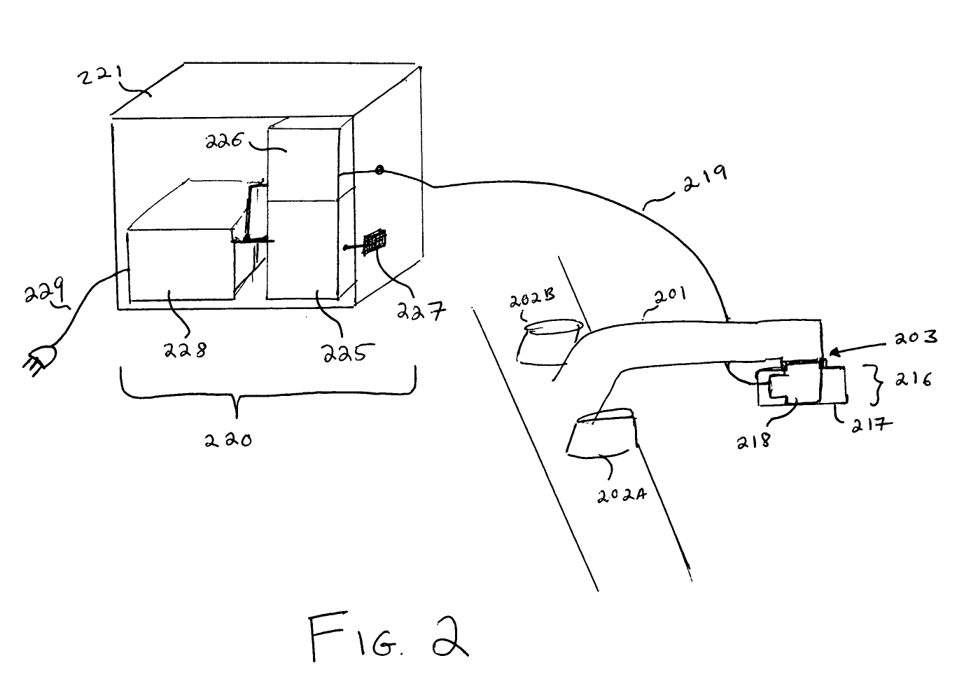

FIG. 2 illustrates a faucet embodiment of the invention in which the valve portion and control unit of the device are remote from one another. Device 210 has a valve portion 216, a control unit 220 and a cord 219 that operably connects the valve portion and control unit. Faucet 201 is connected to hot and cold water controls 202A and 202B and has a water-exiting end 203. Water-exiting end 203 of the faucet 201 has screw threads (not shown) as many standard faucets into which an aerator may be attached. Here, device 210 is attached to faucet 201 by screwing valve portion 216 into the screw threads at the water-exiting end 203. Valve portion 216 includes an outer casing 217 and a two-way, normally open solenoid valve 218. Cord 219 is connected to the solenoid valve 218 and contains electrical wires for energizing the solenoid to close the valve under control of the control unit 220. Control unit 220 includes an outer casing 221, which may for example be made of plastic, a processor control 225, control circuitry 226, a microphone 227 and a power supply 228 for powering the device that connects to a standard electrical outlet via electrical cord 229. Powered by the power supply, the processor controls the state of the valve as described herein in response to voice commands, or sounds commands generally, via the control circuitry by switching the state of the valve via cord 219. Control unit 220 may also be provided with a general power switch (not shown) for turning the device on and off. The on/off switch may, for example, be a water-tight sealed push-button toggle switch. The water-exiting end of device 110 may include and/or be adapted to connect to an aerator, such as a standard faucet aerator for example by having screw threads adapted to connect to an aerator.

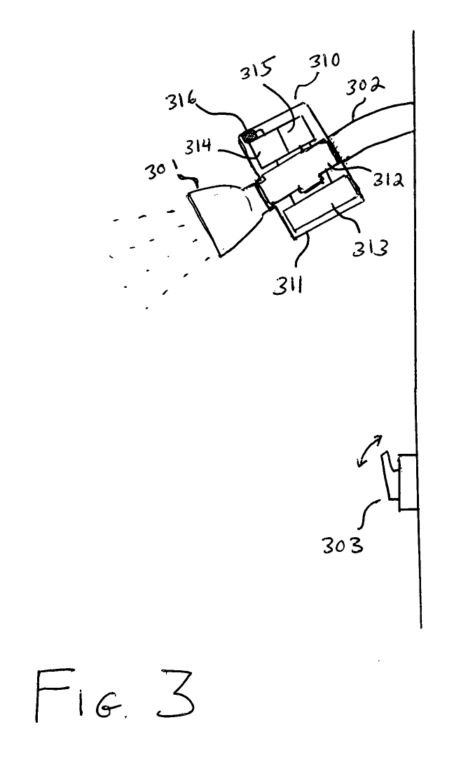

FIG. 3 shows a battery-operated shower embodiment of the invention. Device 310 is substantially the same in design as device 110 of FIG. 1 except device 310 is adapted on its water-receiving end to connect to a shower-feeding water pipe 302 and at its water-exiting end to connect to a showerhead 301. Typically, showerheads are connected to shower-feeding water pipes by screw thread connections and thus device 310 may have complementary screw threads at each end to accommodate pipe 302 and showerhead 301. Device 310 includes an outer casing 311 that contains a two-way, normally open solenoid valve 312, a battery 313, a processor control 314, control circuitry 315 under control of processor 314 and a microphone 316. Powered by the battery, the processor controls the state of the valve as described herein in response to voice commands, or sounds commands generally. Device 310 does not interact with the preexisting manual flow and temperature controls 303 of the shower. Device 310 may also be provided with a general power switch (not shown) for turning the device on and off. The on/off switch may, for example, be a water-tight sealed push-button toggle switch.

A related embodiment invention provides a singular voice and/or sound actuated showerhead device that includes the showerhead component and voice/sound control in one integrated device having a common casing. In one example of this embodiment, a preexisting showerhead may be unscrewed from the source pipe and the integrated device may be screwed on in its place.

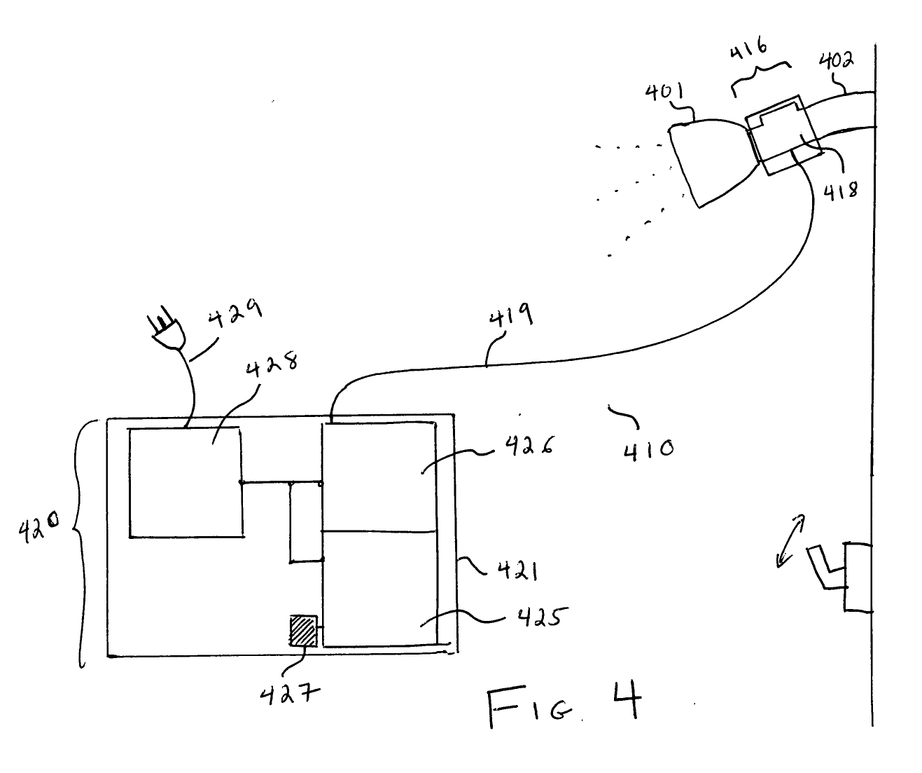

FIG. 4 illustrates a faucet embodiment of the invention in which the valve portion and control unit of the device are remote from one another. Device 410 has a valve portion 416, a control unit 420 and a cord 419 that operably connects the valve portion and control unit. Valve portion 416 has screw thread elements at each of its water-receiving and water-exiting ends and is attached to each of water-supplying pipe 402 and showerhead 401 by screw thread connections. Valve portion 416 includes an outer casing 417, which may for example be made from plastic, and a two-way, normally open solenoid valve 418. Cord 419 is connected to the solenoid valve 418 and contains electrical wires for energizing the solenoid to close the valve under control of the control unit 420. Control unit 420 includes an outer casing 421, which may for example be made of plastic, a processor control 425, control circuitry 426, a microphone 427 and a power supply 428 for powering the device that connects to a standard electrical outlet via electrical cord 429. Powered by the power supply, the processor controls the state of the valve as described herein in response to voice commands, or sounds commands generally. Device 410 does not interact with the preexisting manual flow and temperature controls 403 of the shower. Device 410 may also be provided with a general power switch (not shown) for turning the device on and off. The on/off switch may, for example, be a water-tight sealed push-button toggle switch.

A related embodiment provides a kit that includes a device according to the invention that connects between a shower-supplying pipe and a showerhead to provide voice or sound control of water flow, such as device 310 in FIG. 3 or device 410 in FIG. 4, and a showerhead connected to and/or connectable with the device.

The invention also provides, for example, embodiments similar to those shown in FIGS. 2 and 4 in which the valves are not electrically actuated but are instead pneumatically and/or hydraulically actuated. In this case, the control units may include a pneumatic and/or hydraulic pump or source under control of the processor and the cord includes one or more conduits for transmitting positive or negative pneumatic or hydraulic pressure to the water flow valve of the device to control the valve in accordance with the invention.

Microphones of devices according to the invention may be integral with the main part of the device, as shown in FIGS. 1-4, or may be attached to the device via a cable or cord or may be in wireless communication with the device.

It should be understood that devices according to the invention may use one or more processors. For example, a dedicated voice-recognition chip may be used in connection with a separate but interacting processor control integrated circuit. Integrated circuits and circuits generally as may be used in implementing the invention may be digital and/or analog.

Faucets according to the present invention may, for example, be domestic faucets such as kitchen and bathroom/lavatory sink faucets and shower fixtures may, for example, be domestic shower fixtures. Thus, it may be seen that a primary goal of the invention is to conserve fresh water, clean water and/or potable water. However, the invention is not limited to these preferred embodiments and may be employed to conserve any type or grade of water from any type of faucet, showerhead or other plumbing fixture.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

Each of the patents, patent applications and other publications cited in this disclosure is incorporated by reference in its entirety.

What is claimed is:

1. A water flow control device for conserving water, comprising:
a control unit responsive to voice or sound commands; and
a water flow control valve under control of the control unit;
the device comprising one or more connecting elements sized and configured to operably connect the device to a plumbing fixture selected from the group consisting of a faucet and a shower fixture.

2. The device of claim 2, operably connected to the water-exiting end of a faucet.

3. The device of claim 1, operably connected between a showerhead and the water-exiting end of a water conduit supplying the showerhead.

4. The device of claim 1, wherein the device provides voice or sound actuated control consisting essentially of toggling the valve between an open state and a closed state.

5. A method for conserving fresh water, comprising the step of:
operating a device according to claim 1 by voice or sound actuation to control the amount of the flow of water from a plumbing fixture to which the device is operably connected.

6. The method of claim 5, wherein the step of operating consists essentially of operating the device to start and stop the flow of water from a plumbing fixture to which the device is operably connected.

7. The method of claim 5, wherein the fixture is a faucet and the device is connected to the water-exiting end of the faucet.

8. The method of claim 5, wherein the fixture is a shower fixture comprising a showerhead and the device is attached between the showerhead and a water-exiting end of a water conduit supplying the showerhead.

9. A method for conserving water, comprising the steps of:
installing a device according to claim 1 to a plumbing fixture at or near a water-exiting end of the fixture; and
controlling the amount of flow of water flow by voice or sound actuation of the device,
wherein water is conserved in comparison to operation of the fixture without the device.

10. The method of claim 9, wherein the step of controlling consists essentially of toggling the flow of water between an on state and an off state by voice or sound actuation of the device.

11. The method of claim 9, wherein the fixture is a faucet.

12. The method of claim 11, wherein
the faucet comprises screw threads at the water-exiting end of the faucet,
the device comprises screw threads mateable with the screw threads of the faucet, and
the step of installing the device further comprises attaching the device to the faucet by screw connection of the respective screw threads.

13. A method for conserving water, comprising the steps of:
installing a device according to claim 1 to a shower fixture; and
controlling the amount of flow of water by voice or sound actuation of the device,
wherein water is conserved in comparison to operation of the fixture without the device.

14. The method of claim 13, wherein:
the shower fixture comprises a showerhead connected to a water conduit, and
the step of installing further comprises attaching the device between the showerhead and the water conduit so that the device is connected to each of the showerhead and the conduit.

15. A water flow control device for conserving water, comprising:
a control unit responsive to voice or sound commands;
a water flow control valve under control of the control unit;
a housing, in which the control unit and water flow control valve are commonly housed; and
one or more connecting elements sized and configured to operably connect the device to a plumbing fixture selected from the group consisting of a faucet and a shower fixture,
wherein the device provides voice or sound control of water flow that consists essentially of turning the flow of water on and off.

16. The device of claim 15, wherein the device is battery-powered.

17. The device of claim 15, wherein the device provides voice or sound control of water flow that consists of turning the flow of water on and off.

18. The device of claim 17, wherein the device is battery-powered.

19. A method for conserving water, comprising the steps of:
providing a plumbing fixture with voice or sound actuated control consisting essentially of control of the amount of water flow from the fixture; and
controlling the amount of water flow from the fixture using voice or sound commands.

20. The method of claim 19, wherein the fixture is a faucet.

21. The method of claim 19, wherein the fixture is a shower fixture.

22. The method of claim 19, wherein the provided control consists essentially of turning the flow of water on and off.

23. The method of claim 19, wherein water is conserved by the step of controlling in comparison to operation of the fixture without said controlling.
